(19) United States
(12) Patent Application Publication
(10) Pub. No.: US 2009/0266392 A1
(43) Pub. Date: Oct. 29, 2009

(54) Crutch cushion, crutch system and kit

(76) Inventors: David M. Campbell, Plano, TX (US); William Hirsch, Laconia, NH (US)

Correspondence Address: Lawson & Persson, P.C., P.O. Box 712, Laconia, NH, 03247-0712, US

(21) Appl. No.: 12/150,255

(22) Filed: Apr. 25, 2008

(51) Int. Cl. A61H 99/00; A61H 3/02

(52) U.S. Cl. 135/66; 135/71; 135/72

(57) ABSTRACT

A crutch cushion, a crutch cushion kit and crutch system that includes the crutch cushion. The crutch cushion includes a body having rear, front, right side, left side, top and bottom surfaces, and a hollow chamber proximate to the bottom surface. The top surface slopes downward from the front surface to the rear surface. The right and left side surfaces each have a substantially concave shape. The bottom surface has an oblong opening proximate to and dimensioned to be smaller than a dimension of the hollow chamber.

### FIELD OF THE INVENTION

The present invention relates to the field of crutches and, in particular, to an improved crutch cushion, crutch system, and crutch cushion kit utilizing the crutch cushion and an improved crutch handgrip.

### BACKGROUND OF THE INVENTION

Crutches have been used for many years to allow those with injured or amputated lower extremities to walk. The recommended manner of using crutches is for the user to slightly bend the elbows and lean their weight on their hands such that the crutch cushions covering the shoulder pieces are spaced below the armpit. However, new users of crutches, and users who have become fatigued through extensive use, have a tendency to relax their elbows and allow the crutch cushion to contact the armpit and bear the weight of the user. The incorrect manner of using the crutch during ambulation, and to a lesser extent at rest, may result in serious damage to the brachial plexus and/or pain associated with extended use of the conventional crutch. Further, even when used correctly, ambulating using conventional crutches frequently results in pain, soreness, chafing and skin rashes of the underarm area as well as soreness, and pain in the hands, and damage to the radial nerve.

The two primary points of contact on a crutch are the crutch cushion, which may contact the user's underarm, and the crutch handgrip, which the user grips with his hands. Conventional crutch cushions and handgrips each have significant drawbacks that result in the problems discussed above.

Conventional crutch cushions are manufactured of latex rubber and foam rubber and may or may not be covered with a cloth material. Although they are intended to reduce soreness associated with use of crutches, these cushions are frequently a source of discomfort. Although a new crutch cushion will provide some degree of cushioning, conventional crutch cushions become worn and compressed in only specific areas of the cushion, resulting in unbalanced and ineffective support. Further, the continuous pivoting of the body weight of a user, resulting from the natural walking motion with the use of crutches, causes a constant striking of the crutch head with the front and back of the user's underarm area inside of the upper arms and lateral aspects of the chest wall and ribcage, resulting in jarring, rubbing and abrasion of the underarm area. This rubbing and abrasion is further exacerbated by the fact that most conventional crutches have sides that are planar in form and are not shaped to conform to the arms of the user.

Conventional crutch handgrips are typically manufactured of the same latex rubber and foam rubbers as the crutch cushions and take the form of a hollow cylinder that is fitted around a cylindrical hand support attached to the crutch. Unfortunately, the cylindrical shape of these handgrips is not ergonomic; i.e. it does not readily conform to the shape of the human hand. Further, the handgrip must be sized to allow the user to grasp it, which necessitates a design compromise that prevents the handgrip from providing adequate cushioning; i.e. sufficient padding may not be provided in the area of the handgrip upon which the greatest force is applied. Finally, conventional handgrips rotate about the hand supports, which prevent them from being altered to make them more ergonomic and presents a falling hazard were the grip to rotate during use.

A number of improved crutch cushions have been developed in order to overcome the problems inherent in conventional cushions, but each has significant drawbacks. For example, U.S. Pat. No. 5,865,180, titled “Ergonomic Pad and Pad Holder” discloses a crutch cushion that includes a plush fabric piece having dual overlapping opposing pockets formed therein for housing a viscoelastic gel pad. The pocket is formed in the interior of the cushion holds the gel pad and distributes pressure exerted by the gel pad. The crutch cushion disclosed in this patent is an improvement over conventional cushions insofar as it provides a more conforming side surface, which is helpful when the crutches are used properly. However, this cushion does not address the issue of improving the padding in the area of the crutch proximate to the armpit and, therefore, does nothing to mitigate the effects of misuse of the crutch.

U.S. Pat. No. 5,560,382, titled “Air Cushion Crutch Pad”, discloses a crutch cushion that includes a sealed hollow air chamber that serves as a cushioning means. The use of an air chamber is said to enhance comfort to a user by providing an even distribution of force to the user's underarm area. However, this cushion has significant drawbacks. For example, the cushion disclosed includes straight sidewalls that do not conform to the sides of the user's arms and create rubbing points on the arms during use. This problem is exacerbated when the crutch is used improperly, as the downward pressure on the top of the cushion will tend to force the sidewalls outward. Further, these cushions are prone to collapse due to weaknesses in the materials that can cause air leaks and, therefore, are not sufficiently reliable.

Another improvement is disclosed in PCT Published Patent Application No. WO2006047413, titled “Crutch”. This publication describes a crutch system that differs significantly from conventional crutch systems and includes an integrated crutch cushion that surrounds an L-shaped top crutch bar. The crutch cushion of this publication is an improvement over conventional designs insofar as the sides have a concave shape that conforms to the user's arms. Further, the use of a foam having memory characteristics helps to better distribute forces and prevent breakdown of the cushion. However, the crutch cushion of this system is not without its drawbacks; the most important of which is the inability of the crutch cushion to be successfully adapted for use with conventional crutches.

The use of memory foam provides distinct advantages, but its use also creates certain design challenges that must be overcome. These challenges are how to design the cushion such that it may be readily attached to the crutch head without tearing, and how to shape the cushion in order to prevent it from folding over during use. The design shown in this publication avoids the attachment issue by including a through-hole in which a cantilevered support is disposed, but the same design will not work with a conventional crutch head. Further, because the crutch cushion must be fitted over the L-shaped crutch bar without tearing, it must be manufactured of a flexible material that is inherently prone both to fully compressing and to rolling over on itself. Finally, the rounded crown of the top surface of the cushion is not ergonomic and exposes the user to the risk of misplacement of the cushion under the arm, which exerts an angular force on the crutch that can lead to the crutch becoming separated from the user and can cause pain and injury to the brachial plexus.

Therefore, there is a need for an improved crutch cushion that is adapted for use with conventional crutches that provides enhanced cushioning to the brachial plexus, that has sides that are shaped to conform to shape of the user's arm; that is not prone to collapse, that will not tear when attached to a conventional crutch head, that will not roll over on itself when attached to a conventional crutch head, and that is ergonomically designed so as to reduce the risk that the cushion will be misplaced under the arm of the user.

### SUMMARY OF THE INVENTION

The present invention is a crutch cushion, a crutch cushion kit for attachment to a crutch and a crutch system that includes the crutch cushion. In its most basic form, the crutch cushion includes a body having a rear surface, a front surface, a right side surface, a left side surface, a top surface, a bottom surface, and a hollow chamber proximate to the bottom surface. The top surface intersects the rear, front, right side, and left side surfaces and slopes downward from the front surface to the rear surface. The right side surface and the left side surface each have a substantially concave shape. The bottom surface has an oblong opening therethrough, which is proximate to the hollow chamber and dimensioned to be smaller than a dimension of the hollow chamber. The bottom surface also includes a front notched depression and a rear notched depression disposed proximate to the oblong opening. Finally, the body is manufactured of a viscoelastic material and is dimensioned such that the body will not collapse completely against a head of a crutch and will not roll over the head of the crutch when the user places weight on the top surface of the cushion.

In the preferred crutch cushion the top surface also includes a rear transition portion between the top surface and the rear surface, a front transition portion between the top surface and the front surface, a right transition portion between the top surface and the right surface, and a left transition portion between the top surface and the left surface. Each of the transition portions is substantially rounded to minimize pressure points. The top surface of the preferred crutch cushion is also sloped to form a curved surface having a radius of between forty inches and fifty-five inches.

In the preferred crutch cushion, the viscoelastic material is a methylene di-phenyl di-isocyanate foam formulation (hereafter referred to as “MDI foam”) and the body is dimensioned such that a distance from the bottom surface to a tallest point on the top surface is between 3.75 inches and 4.25 inches and such that a distance from the bottom surface to a shortest point on the top surface is between 2.8 inches and 3.5 inches.

In the preferred crutch cushion, the bottom surface also includes a substantially horizontal main surface through which the oblong opening is disposed, a rear angled surface disposed between the main surface and the rear surface of the body, and a front angled surface disposed between the main surface and the rear surface of the body. The front angled surface and the rear angled surface each are disposed at an angle upward from the main surface toward the top surface.

It is preferred that the rear surface and the front surface are each rounded and that the radius of each of the front surface and the rear surface proximate to the top surface is smaller than the radius of each of the front surface and the rear surface proximate to the bottom surface. It is also preferred that each of the right side surface and left side surface are angled outward from the top surface toward the bottom surface and that the right side surface and left side surface are each disposed at a substantially equal radius of between eighteen inches and thirty inches. In the preferred embodiment, the right side surface and left side surface are angled outward such that a right plane touching the right side surface proximate to the top surface and the bottom surface and a left plane touching the left side surface proximate to the top surface and the bottom surface intersect to form an angle of between five degrees and fifteen degrees.

In some embodiments, at least the rear notched depression includes a slit and a round opening formed therein, the slit extending into the notched opening from the oblong opening in the bottom surface of the body and terminating in the round opening. This slit is intended to further ease the mounting and dismounting of the cushion on the head of the crutch without tearing while the round opening is intended to provide stress relief such that the slit does not continue to extend beyond the round opening.

The kit of the present invention is intended for assembly to a crutch having a head. The basic embodiment of the kit includes the crutch cushion of the present invention and a crutch handgrip. The crutch handgrip has a handgrip body including a top surface, a first end, a second end, a right surface, a left surface, and bore disposed through the handgrip body from the first end to the second end. The bore is dimensioned to allow a handgrip bar to extend through the body, the first end and the second end each have a substantially triangular shape and the handgrip body is manufactured of a viscoelastic foam material.

The preferred handgrip has a handgrip body that is substantially planar from the first end to the second end and includes rounded transition portions proximate to the right surface and the left surface. It is also preferred that the right surface and the left surface of the handgrip body each have a convex shape.

The preferred embodiment of the kit also includes a cushion cover dimensioned to fit about the rear surface, the front surface, the right side surface, the left side surface, the top surface, and a portion of the bottom surface of the crutch cushion. The cushion cover is manufactured of fabric, fleece, microsuade, or non-woven fabrics such as neoprene, and includes means for securing the cushion cover to the crutch cushion. The preferred cushion cover includes an outside surface having at least one logo.

Finally, the crutch system of the present invention includes the crutch cushion and crutch handgrip attached to a crutch. The crutch includes a crutch head including a front horn, a rear horn, a top surface and a bottom surface, at least one support leg attached to and extending from the bottom surface of the crutch head and a hand support is attached to at least one support leg.

In the preferred embodiment, the crutch is a conventional crutch having two support legs and a dowel extending between the support legs to form the hand support. In some embodiments of the crutch system, the crutch includes a single support leg and the hand support extends in cantilevered fashion from the support leg.

Therefore, it is an aspect of the invention to provide an improved crutch cushion that is adapted for use with conventional crutches that provides enhanced cushioning to the brachial plexus.

It is a further aspect of the invention to provide an improved crutch cushion that is adapted for use with conventional crutches that has sides that are shaped to conform to the shape of the user's arm and ribs.

It is a further aspect of the invention to provide an improved crutch cushion that is adapted for use with conventional crutches and that is not prone to collapse.

It is a further aspect of the invention to provide an improved crutch cushion that is adapted for use with conventional crutches that will not tear during the process of mounting it to a conventional crutch head.

It is a further aspect of the invention to provide an improved crutch cushion that is adapted for use with conventional crutches that will not buckle when attached to a conventional crutch head.

It is a further aspect of the invention to provide an improved crutch cushion that is adapted for use with conventional crutches that is ergonomically designed so as to reduce the risk that the cushion will be misplaced under the arm of the user.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a side view of the preferred embodiment of the crutch cushion of the present invention.

FIG. 2 is a bottom view of the preferred embodiment of the crutch cushion of the present invention.

FIG. 3 is a top view of the preferred embodiment of the crutch cushion of the present invention.

FIG. 4 is an isometric view of the preferred hand grip of the crutch system of the present invention.

FIG. 5 is a top view of the preferred hand grip of the crutch system of the present invention.

FIG. 6 is an end view of the preferred handgrip of the crutch system and kit of the present invention.

FIG. 7 is a bottom view of an alternative embodiment of the crutch cushion of the present invention in which slits are disposed from the ends of the oblong opening.

FIG. 8A is an assembly view showing the preferred crutch cushion and the head of a crutch prior to the crutch cushion being mounted on the crutch.

FIG. 8B is an assembly view showing the first step in the installation of the preferred crutch cushion to the head of a crutch.

FIG. 8C is an assembly view showing the second step in the installation of the preferred crutch cushion to the head of a crutch.

FIG. 8D is an assembly view showing the preferred crutch cushion installed upon the head of a crutch.

FIG. 9 is a side view of one embodiment of the kit of the present invention in which the crutch cushion includes a decorative cover disposed over the cushion.

FIG. 10 is a side view of the preferred crutch system of the present invention in which the hidden portions of the crutch are shown in dashed lines.

FIG. 11 is an isometric view of the preferred hand support of the crutch system of the present invention.

FIG. 12 is a cross sectional view of an alternative embodiment of the crutch cushion of the present invention that is manufactured from two different materials.

FIG. 13 is a side view of an alternative crutch system of the present invention having only one support leg and in which the hidden portions of the crutch are shown in dashed lines.

FIG. 14 is an isometric view of the preferred grip of the crutch system of the present invention in which the handgrip is molded about a star shaped hand support.

### DETAILED DESCRIPTION OF THE INVENTION

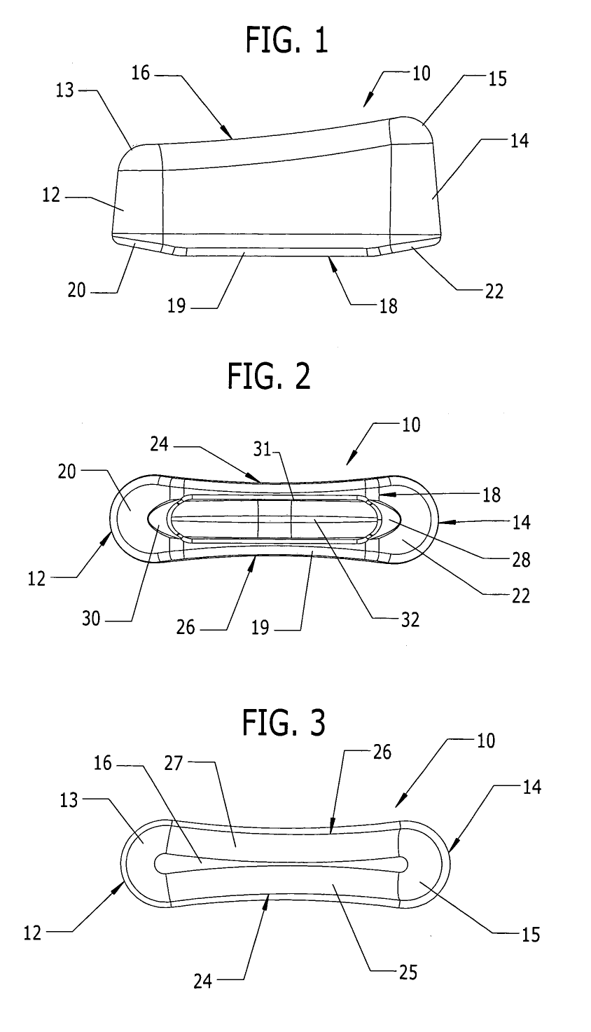

Referring first to FIGS. 1-3, the preferred crutch cushion 10 of the present invention is shown. The preferred crutch cushion 10 has a rear surface 12, a front surface 14, a top surface 16, a bottom surface 18, a right side surface 24, and a left side surface 26. The combination of the material from which the crutch cushion 10 is made and its overall geometry are such that the crutch cushion 10 will not collapse completely against the crutch and will not roll over when a user's weight, defined as weight of up to one-hundred and fifty pounds, is placed on the crutch cushion 10.

The preferred crutch cushion 10 is manufactured of a single type of open-cell viscoelastic memory foam, preferably having an MDI foam formulation. An MDI foam formulation is preferred because it is viscoelastic, softens at body temperature, is highly resilient, i.e. it reverts to its original shape after the user's weight in removed; and is biocompatible, i.e. it passes skin sensitization testing and contains no latex rubber. Although an MDI foam formulation is preferred, other viscoelastic open-cell foam formulations, such as toluene di-isocyanate foam (TDI foam), may be substituted to achieve similar results. The primary requirement of any foam rubber used in the manufacture of the crutch cushion 10 is that it be viscoelastic, that it does not fully compress when a user places his weight against it, and that it will not roll over when it is shaped and dimensioned as set forth below. A secondary requirement is that the foam rubber provides a substantially even weight distribution across it entire profile such that pressure points are minimized.

In some embodiments of the invention, the crutch cushion 10 is manufactured from two different types of foam materials. A cross sectional view of one such embodiment is shown in FIG. 12. In this embodiment, the top portion 80 is manufactured of a softer, memory foam type, foam in order to provide enhanced cushioning, while the bottom portion 82 is manufactured of a firmer, high resiliency type, foam in order to avoid full compression of the cushion 10.

As shown in FIG. 3, top surface 16 preferably includes four substantially smooth transition portions 13, 15, 25, 27, that are intended to eliminate any sharp edges that could irritate the user's arm or torso. Rear transition portion 13 creates a transition between the top surface 16 and rear surface 12, front transition portion 15 creates a transition between the top surface 16 and front surface 14, right transition portion 25 creates a transition between the top surface 16 and right side surface 24, and left transition portion 27 creates a transition between the top surface 16 and left side surface 26. It is preferred that each of the transition portions 13, 15, 25, 27 be rounded surfaces. In the preferred embodiment, the rear transition portion 13 and front transition portion 15 each have a substantially equal radius of between 0.63 inches and one inch, and that right transition portion 25 and left transition portion 27 each have a substantially equal radius of between 2.25 inches and 2.75 inches. However, in other embodiments, the transition portions 13, 15 and 25, 27 have different radii, while still others may have parabolic or other curved profiles.

As shown in FIG. 1, the top surface 16 slopes downward from the front transition portion 15 toward the rear transition portion 13. In use, the crutch system of the present invention is preferably adjusted so that the front transition portion 15 is at the same height as that of the cushions of conventional crutches. As this is the case, the downward slope of the top surface 16 is an important aspect of the invention, as it acts to prevent chafing of the user's underarm by the crutch cushion 10 and provides the user with feedback to assist the user in properly positioning and using the crutch; i.e. the user should not contact the crutch cushion 10 during normal use and, if the top surface 16 is in contact with the user, the user knows that the crutch is not properly positioned or that their body is incorrectly positioned relative to the crutch. The downward slope of the top surface 16 also helps to prevent the crutch from slipping backward out from under the arm during use.

In the preferred embodiment, which uses an MDI foam formulation, the height of the cushion 10 is between 3.75 inches and 4.25 when measured from the bottom surface 18 to the tallest point on the top surface 16 and between 2.8 inches and 3.5 inches when measured from the bottom surface 18 to the shortest point on the top surface 16. However, the height of cushion 10 may vary depending upon the foam formulation used, provided the height is such that the cushion 10 will not completely compress or roll over when weight is applied to the top surface 16 by the user.

It is preferred that the top surface 16 be a curved surface having a radius of between forty inches and fifty-five inches. A curved top surface 16 is preferred as it is more ergonomic and more accurately duplicates the contours of a human underarm than other surfaces. However, in other embodiments the top surface is sloped to form a plane having an angle of between five and fifteen degrees when measured from a horizontal plane intersecting the top surface 16. Thus, in the context of this invention, the term “sloped” means that the top surface 16 moves progressively downward from the front transition portion 15 to the rear transition portion 13.

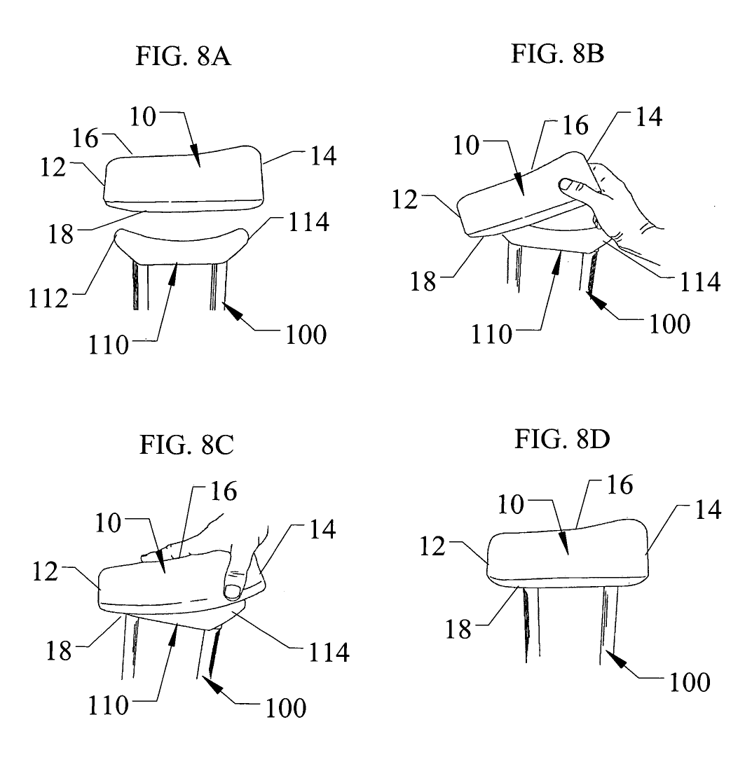

As shown in FIG. 2, the bottom surface 18 of the crutch cushion 10 includes a substantially horizontal main surface 19, a rear angled surface 20 and a front angled surface 22. The main surface 19 includes an oblong opening 31 through which the crutch head (not shown) is inserted into the hollow chamber 32. The opening 31 is smaller than the hollow chamber 32 and acts to secure the crutch head within the hollow chamber 32 once it is fully inserted in the mariner described in connection with FIGS. 8A-8D.

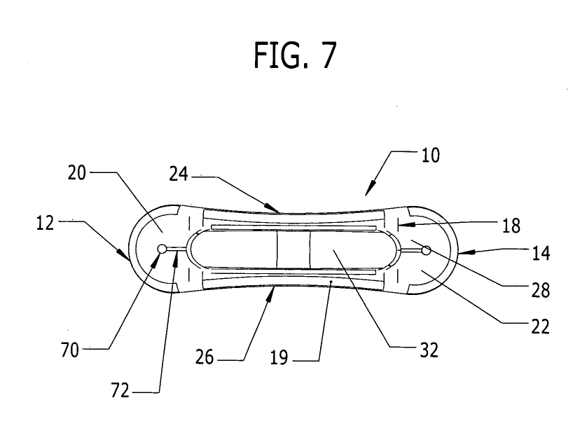

Notched depressions 28, 30 are disposed proximate to the front and rear edges of the oblong opening 31 and extend into the front angled surface 22 and rear angled surface 20. The notched depressions 28, 30 are an important aspect of the invention, as they allow the crutch head to be inserted within the hollow chamber 32 of the crutch cushion 10 without tearing the material from which the crutch cushion 10 is formed. This is because the notched depressions 28, 30 act to guide the ends of the crutch head into the opening 31 and because they reduce the material thickness at these locations to allow for additional stretching. In the preferred embodiment, the crutch cushion 10 includes two notched depressions 28, 30. However, other embodiments may include a single notched depression. Further, in some embodiments, such as those shown in FIG. 7, the notched depressions 28, 30 are replaced by a round opening 70 and a slit 72 therethrough, which also allow the crutch head to be inserted within the hollow chamber 32 of the crutch cushion 10 without tearing the material from which the crutch cushion 10 is formed. As was the case with the notched depressions 28, 30; the crutch cushion 10 may include two sets of round openings 70 and slits 72, or may only have a single round opening and slit. The rear angled surface 20 and front angled surface 22 of the bottom surface are also preferably included in order to reduce material thickness about the crutch head and allow for additional stretching without tearing. However, these surfaces may be omitted in some embodiments.

The rear surface 12 and front surface 14 of the crutch cushion 10 are each rounded and take on a slightly conical shape with the junction between the surfaces 12, 14 and transition portions 13, 15 having a slightly smaller radius than the junction between the rear and front surfaces 12, 14 and bottom surface 18. It is preferred that the rear surface 12 and front surface 14 of the crutch cushion 10 are rounded as such a shape eliminates pressure points that can cause irritation to the user.

The right side surface 24 and left side surface 26 are each slightly concave and preferably angled outward from the top surface 16 to the bottom surface 18. The surfaces 24, 26 are preferably angled together such that a plane touching the right side surface 24 proximate to the top surface 16 and bottom surface 18 and a plane touching the left side surface 26 proximate to the top surface 16 and bottom surface 18 intersect to form an angle of between five degrees and fifteen degrees; preferably ten degrees. In the preferred embodiment, the right side surface 24 and left side surface 26 each form an equal radius of between eighteen and thirty inches, with the preferred radius being approximately twenty-four inches. These surfaces 24, 26 are shaped in this manner in order to better conform to the torso and arm of the user, and to act as a further aid in preventing the crutch from slipping out from under the user's arm.

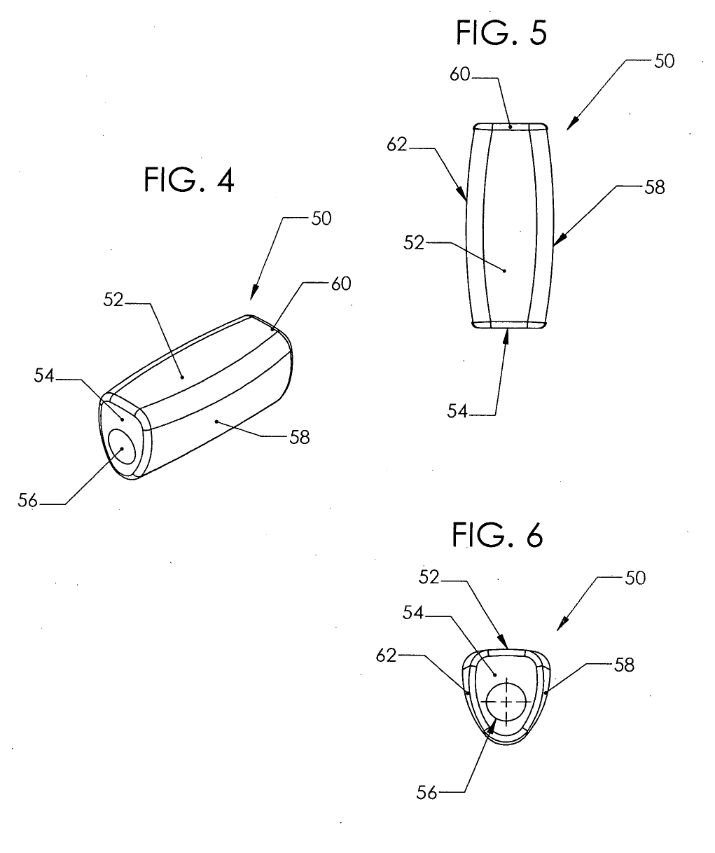

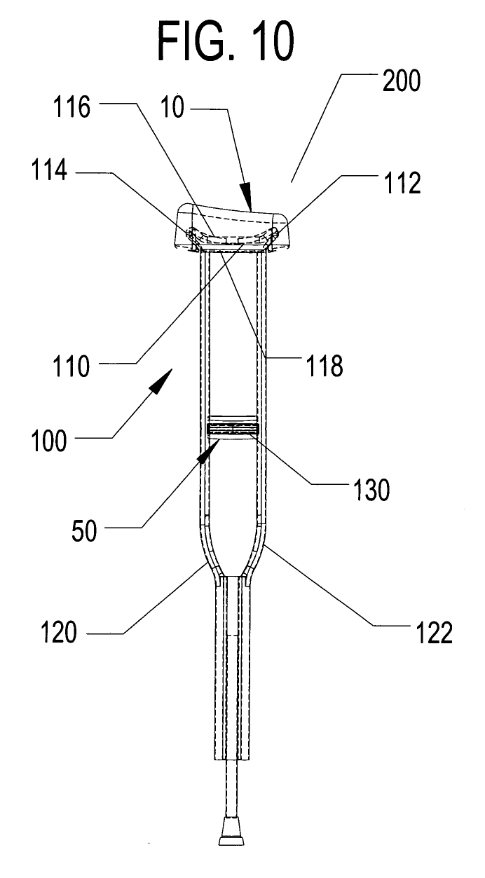

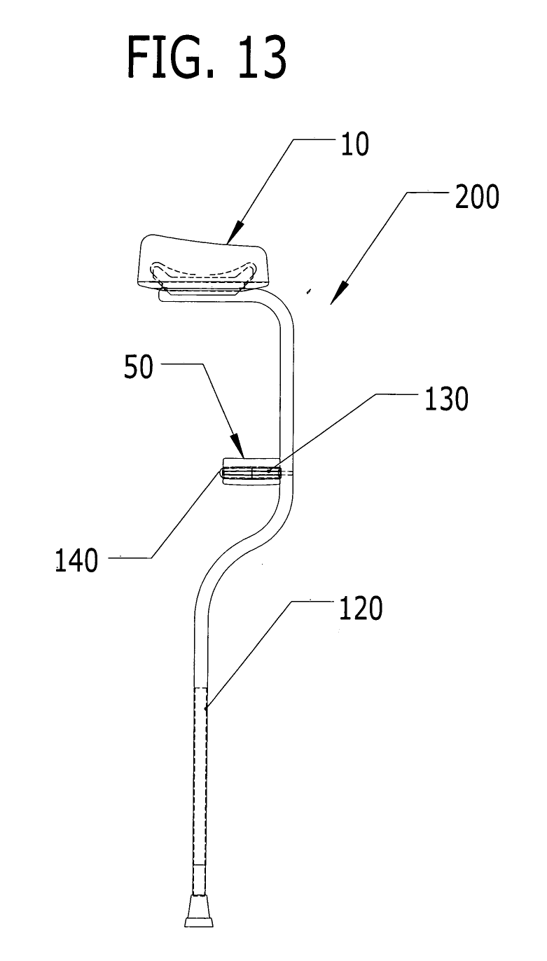

The crutch cushion 10 of FIGS. 1-3 may be sold as a stand alone product for use as a replacement for conventional crutch cushions, may be packaged as part of a kit with a handgrip, such as the handgrip 50 shown in FIGS. 4-6, or may be sold as part of a crutch system, such as the crutch systems 200 shown in FIGS. 10 and 13. Regardless of how it is sold, the preferred crutch cushion 10 is installed upon the crutch head in the manner shown in FIGS. 8A-8D.

As shown in FIG. 8A, the crutch 100 includes a conventional head 110 having a front horn 114 and a rear horn 112. As shown in FIG. 8B, the first step in installing the cushion 10 is to align the bottom surface 18 with the head 110 of the crutch 100 and angle the rear surface 12 upward. As shown in FIG. 8B, the rear horn 112 of the head 110 of the crutch 100 is then inserted into the opening 31 (See FIG. 2) in the bottom surface 18 of the cushion 10 proximate to the rear surface 12. However, in other embodiments, the front horn 112 of the head of the crutch 100 may be inserted into the opening 31 in the bottom surface 18 of the cushion 10 proximate to the front surface 14.

As shown in FIG. 8C, the next step in installing the cushion 10 is to slide the cushion 10 toward the front surface 14 such that the rear horn (not shown) of the head 110 of the crutch is engaged with the inside surface of the hollow chamber 32 within the cushion 10 proximate to the rear surface 12. The front surface 14 of the cushion 10 is then rotated downward toward the head 110 of the crutch 100 such that the notched depression 30 (See FIG. 2) rests upon the front horn 114 of the head 110. The front surface 14 of the cushion 10 is then stretched and pushed downward such that the front horn 114 of the head 110 passes through the opening 31. As shown in FIG. 8D, the cushion 10 is then released and automatically returns to its natural shape, which causes the inside surface of the hollow chamber 32 within the cushion 10 to engage the head of the crutch 10, and is straightened to ensure that is evenly and squarely positioned oh the crutch head 110.

As noted above, the crutch cushion of the present invention may be combined with a handgrip and sold as a kit. Referring now to FIGS. 4-6, the preferred handgrip 50 of the present invention is shown. The handgrip 50 includes a top surface 52, a first end, 54, a second end 60, a right surface 58, and a left surface 62. A bore 56 is disposed through the first end 54 and extends through the handgrip 50 to the second end 60 to allow a hand support (not shown) to extend therethrough.

The preferred handgrip 50 is manufactured of a single type of foam material having a slightly firmer formulation of the same MDI foam material as the preferred crutch cushion 10. The use of a firmer formulation of MDI foam is preferred because, during proper use of the crutch 100, the top surface 52 of the handgrip 50 bears a significant portion of the users weight and the wall thickness of the top surface 52 must be less than that of the crutch cushion 10 to comfortably fit the user's hand. Thus, a firmer formulation has been found to better support this weight without bottoming out on the hand support. However, any cushioning material that supports the users weight without fully compressing, will not rollover, and provides a substantially even weight distribution across it entire profile, may be utilized to achieve similar results. In other embodiments, the handgrip may be manufactured from the same MDI formulation as the cushion. Still others are manufactured from two different foam formulations, with the portion proximate the top surface 52 being manufactured of a softer foam than the second foam. In still other embodiments, the handgrip 50 is manufactured from a foam material bonded to a plastic material, with the portion proximate the top surface 52 being manufactured of the foam material and the remainder manufactured from a plastic material.

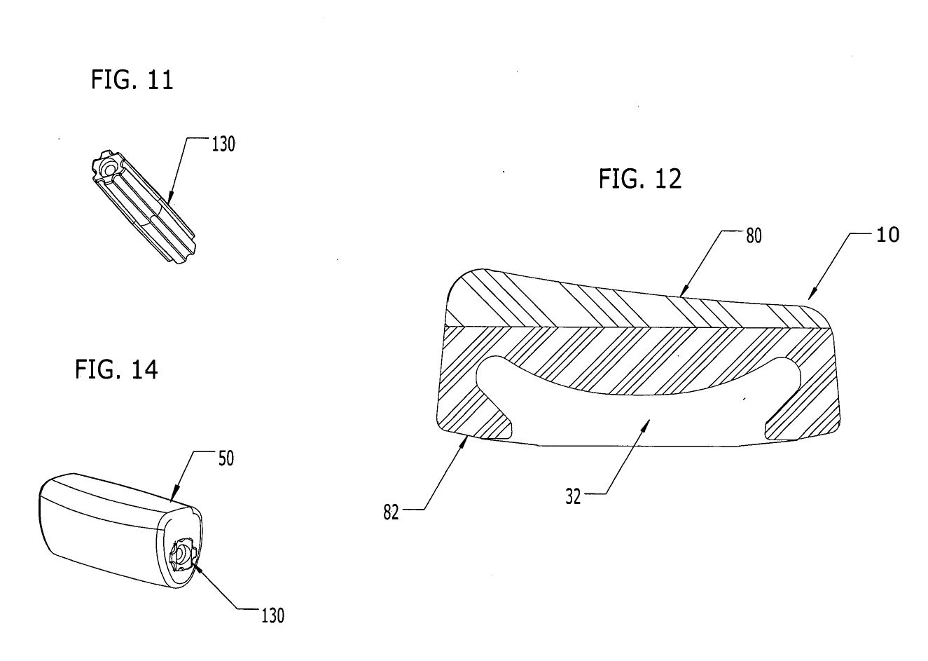

As shown in FIG. 11, the preferred hand support 130 is a star shaped dowel pin that is dimensioned to fit within the bore in the handgrip 50. The star shape is preferred due to its ability to prevent rotation of the handgrip 50 about the hand support 130, which is important due to the unidirectional nature of the triangular handgrip 50. In the preferred embodiment, hand support 130 is manufactured of a hard plastic material and the handgrip 50 is molded about the hand support 130, as shown in FIG. 14.

The first end 54 and second end 60 each have a substantially triangular shape with rounded corners. This shape is preferred as it is more ergonomic than conventional cylindrical handgrips, which is due to the fact that human fingers more naturally fit around a triangular shape than a cylindrical one. Further, this shape allows more material to be disposed in the areas in which the most padding is required, allowing the handgrip 50 to more readily conform to the hand. The top surface 52 is substantially planar from the first end 54 to the second end 60 and has rounded transition portions proximate to the right surface 58 and left surface 62. The right surface 58 and left surface 62 each preferably have a convex shape, with the central portion of the handgrip 50 being wider than the portions proximate to the first end 54 and second end 60. The convex shape is preferred as it better conforms to the shape of a human hand.

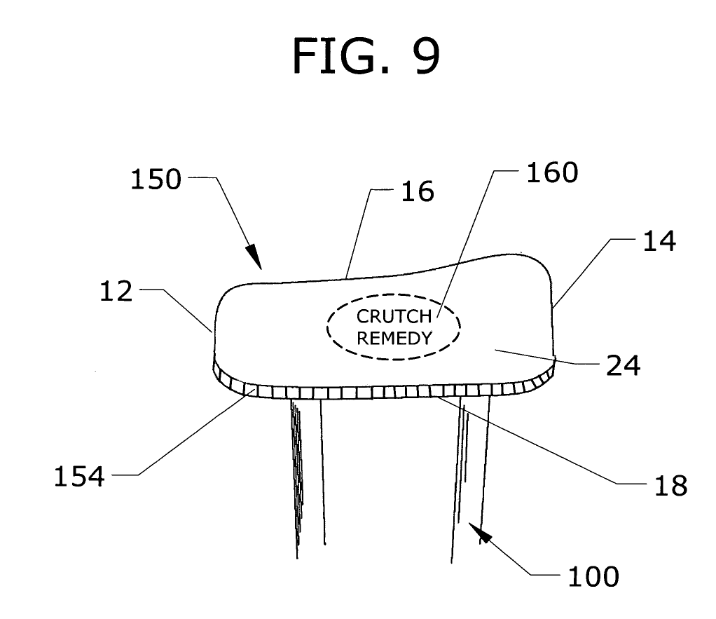

Referring now to FIG. 9, the kit of the present invention may include a cushion covet 150 dimensioned to fit about the rear surface 12, the front surface 14, the right side surface 24, the left side surface (not shown), the top surface 16, and a portion of the bottom surface 18 of the crutch cushion 10. The cushion cover 150 is manufactured of fabric, fleece, microsuade. Or non-woven fabrics such as neoprene. The preferred cushion cover 150 includes an elastic band 154 sewed about its open end for securing the cushion cover 150 to the crutch cushion 10. However, drawstrings, snaps, or other art recognized means for securing covers to crutches may be substituted for the elastic band 154 to achieve similar results. The preferred cushion cover 150 includes an outside surface having at least one logo 160 disposed thereon. The logo 160 may take many forms, including the logos of professional sports teams, colleges, or the like. Although the logo 160 is shown on the side surface 24 of the crutch cushion 10, it may also be placed on the front surface 14 or rear surface 13.

Referring now to FIG. 10, the crutch system 200 of the present invention is shown. The preferred crutch system 200 includes the preferred crutch cushion 10 of FIGS. 1-3, the preferred handgrip 50 of FIGS. 4-6 and a conventional crutch 100. The crutch includes a crutch head 110 including a front horn 114, a rear horn 112, a top surface 116 and a bottom surface 118. A pair of support legs 120, 122 is attached to and extends from the bottom surface 118 of the crutch head 110. A hand support 130 is attached between the support legs 120, 122. The crutch cushion 10 is mounted over the crutch head 110 and the hand support 130 is disposed through the bore in the handgrip 50.

Finally, as shown in FIG. 13, an alternative embodiment of the crutch system includes a crutch 100 having a single support leg 120. In this embodiment, the crutch head 110 is similar in all respects to the conventional crutch head 110 of FIG. 10, except that it is manufactured of a material that will withstand the additional forces on the bottom surface 118 as a result of having only a single point of contact. In this embodiment, the hand support 50 extends in cantilevered fashion from the support leg 120 and preferably includes a threaded interior portion (not shown) that allows a protective end cap 140 to be installed over the end of the handgrip 50.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A crutch cushion comprising:
a body comprising a rear surface, a front surface, a right side surface, a left side surface, a top surface, a bottom surface, and a hollow chamber proximate to said bottom surface;
wherein said top surface intersects said rear surface, said front surface, said right side surface and said left side surface and slopes downward from said front surface to said rear surface;
wherein said right side surface and said left side surface each have a substantially concave shape;
wherein said bottom surface comprises an oblong opening therethough, said oblong opening being proximate to said hollow chamber and dimensioned to be smaller than a dimension of said hollow chamber;
wherein said body is manufactured of at least one viscoelastic material and is dimensioned such that said body will not collapse completely against a head of a crutch and will not roll over said head of said crutch when a weight is placed on said top surface of said cushion.

2. The crutch cushion as claimed in claim 1 wherein said top surface further comprises a rear transition portion between top surface said and tear surface, a front transition portion between said top surface and said front surface, a right transition portion between said top surface and said right surface, and a left transition portion between said top surface and said left surface, and wherein each of said front transition portion, said rear transition portion, said right transition portion and said left transition portion are substantially rounded.

3. The crutch cushion as claimed in claim 1 wherein said top surface is sloped to form a curved surface having a radius of between forty inches and fifty-five inches.

4. The crutch cushion as claimed in claim 1 wherein said viscoelastic material is a single viscoelastic material having an MDI foam formulation and wherein said body is dimensioned such that a distance from said bottom surface to a tallest point on said top surface is between 3.75 inches and 4.25 inches and such that a distance from said bottom surface to a shortest point on said top surface is between 2.8 inches and 3.5 inches.

5. The crutch cushion as claimed in claim 1 wherein said bottom surface further comprises a substantially horizontal main surface through which said oblong opening is disposed, a rear angled surface disposed between said main surface and said rear surface of said body, and a front angled surface disposed between said main surface and said rear surface of said body, and wherein each of said front angled surface and said rear angled surface is disposed at an angle upward from said main surface toward said top surface.

6. The crutch cushion as claimed in claim 1 wherein said bottom surface further comprises at least one notched depression disposed proximate to said oblong opening.

7. The crutch cushion as claimed in claim 1 wherein said bottom surface further comprises at least one slit and at least one round opening formed therethrough, wherein said at least one slit extends from said oblong opening toward one of said front surface and said rear surface and terminates in said round opening.

8. The crutch cushion as claimed in claim 1 wherein said rear surface and said front surface are each rounded and wherein a radius of each of said front surface and said rear surface proximate to said top surface is smaller than a radius of each of said front surface and said rear surface proximate to said bottom surface.

9. The crutch cushion as claimed in claim 1 wherein each of said right side surface and left side surface are angled outward from said top surface toward said bottom surface.

10. The crutch cushion as claimed in claim 9 wherein said right side surface and left side surface angled outward such that a right plane touching said right side surface proximate to said top surface and said bottom surface and a left plane touching said left side surface proximate to said top surface and said bottom surface intersect to form an angle of between five degrees and fifteen degrees.

11. The crutch cushion as claimed in claim 1 wherein said right side surface and left side surface are each disposed at a substantially equal radius of between eighteen inches and thirty inches.

12. A kit of parts for assembly to a crutch, said kit of parts comprising:
a crutch cushion comprising:
a cushion body comprising a rear surface, a front surface, a right side surface, a left side surface, a top surface, a bottom surface, and a hollow chamber proximate to said bottom surface;
wherein said top surface intersects said rear surface, said front surface, said right side surface and said left side surface and slopes downward from said front surface to said rear surface;
wherein said right side surface and said left side surface each have a substantially concave shape;
wherein said bottom surface comprises an oblong opening therethrough, said oblong opening being proximate to said hollow chamber and dimensioned to be smaller than a dimension of said hollow chamber; and
wherein said cushion body is manufactured of at least one viscoelastic-material and is dimensioned such that said body will not collapse completely against a head of a crutch and will not roll over said head of said crutch when a weight is placed on said top surface of said cushion; and
a crutch handgrip comprising:
a handgrip body comprising a top surface, a first end, a second end, a right surface, a left surface, and bore disposed through said handgrip body from said first end to said second end;
wherein said bore is dimensioned to allow a handgrip bar to extend through said body;
wherein said first end and said second end each have a substantially triangular shape; and
wherein said handgrip body is manufactured of at least one viscoelastic foam material.

13. The kit as claimed in claim 12 wherein said top surface of said crutch cushion is sloped to form a curved surface having a radius of between forty inches and fifty-five inches.

14. The kit as claimed in claim 12 wherein said crutch cushion is made from a single viscoelastic material having an MDI foam formulation and wherein said cushion body is dimensioned such that a distance from said bottom surface to a tallest point on said top surface is between 3.75 inches and 4.25 inches and such that a distance from said bottom surface to a shortest point on said top surface is between 2.8 inches and 3.5 inches.

15. The kit as claimed in claim 12 wherein said bottom surface of said crutch cushion further comprises at least one notched depression disposed proximate to said oblong opening.

16. The kit as claimed in claim 12 wherein said bottom surface of said crutch cushion further comprises at least one slit and at least one round opening formed therethrough, wherein said at least one slit extends from said oblong opening toward one of said front surface and said rear surface and terminates in said round opening.

17. The kit as claimed in claim 12 wherein each of said right side surface and left side surface of said crutch cushion are angled outward from said top surface toward said bottom surface.

18. The kit as claimed in claim 12 wherein said top surface of said handgrip body is substantially planar from said first end to said second end and comprises rounded transition portions proximate to said right surface and said left surface.

19. The kit as claimed in claim 12 wherein said right surface and said left surface of said handgrip body each have a convex shape.

20. The kit as claimed in claim 12 further comprising a cushion cover dimensioned to fit about said rear surface, said front surface, said right side surface, said left side surface, said top surface, and a portion of said bottom surface of said crutch cushion, wherein said cushion cover comprises means for securing said cushion cover to said crutch cushion.

21. The kit as claimed in claim 20 wherein said cushion cover comprises an outside surface having at least one logo.

22. The kit as claimed in claim 18 wherein said crutch handgrip further comprises a hand support and wherein said crutch handgrip is permanently attached to said hand support.

23. The kit as claimed in claim 20 wherein said hand support is substantially star shaped.

24. A crutch system comprising:
a crutch comprising:
a crutch head comprising a front horn, a rear horn, a top surface and a bottom surface;
at least one support leg attached to and extending from said bottom surface of said crutch head; and
a hand support attached to said at least one support leg;
a crutch cushion disposed upon said crutch head, said crutch cushion comprising:
a cushion body comprising a rear surface, a front surface, a right side surface, a left side surface, a top surface, a bottom surface, and a hollow chamber proximate to said bottom surface within which said crutch head is disposed;
wherein said top surface intersects said rear surface, said front surface, said right side surface and said left side surface and slopes downward from said front surface to said rear surface;
wherein said right side surface and said left side surface each have a substantially concave shape;
wherein said bottom surface comprises an oblong opening therethough, said oblong opening being proximate to said hollow chamber and dimensioned to be smaller than a dimension of said hollow chamber; and
wherein said cushion body is manufactured of a viscoelastic material and is dimensioned such that said body will not collapse completely against said crutch head and will not roll over said crutch head when a weight is placed on said top surface of said cushion; and
a crutch handgrip attached to said hand support, said crutch handgrip comprising:
a handgrip body comprising a top surface, a first end, a second end, a right surface, a left surface, and bore disposed through said handgrip body from said first end to said second end;
wherein said bore is dimensioned to allow a handgrip bar to extend through said body;
wherein said first end and said second end each have a substantially triangular shape; and
wherein said handgrip body is manufactured of a viscoelastic foam material.

25. The crutch system as claimed in claim 24 wherein said crutch comprises one support leg attached to and extending from said bottom surface of said crutch head.

26. The crutch system as claimed in claim 24 wherein said crutch comprises two support legs attached to and extending from said bottom surface of said crutch head.

27. The crutch system as claimed in claim 24 further comprising a cushion cover fitted about said rear surface, said front surface, said right side surface, said left side surface, said top surface, and a portion of said bottom surface of said crutch-cushion, and secured to said crutch cushion.

28. The crutch system as claimed in claim 24 wherein said crutch handgrip further comprises a hand support and wherein said crutch handgrip is permanently attached to said hand support.

29. The crutch system as claimed in claim 28 wherein said hand support is substantially star shaped.
